(19) United States
(12) Patent Application Publication
(10) Pub. No.: US 2010/0116073 A1
(43) Pub. Date: May 13, 2010

(54) Actuator with an anti-loose structure

(76) Inventor: FU-YUAN CHENG, TAICHUNG (TW)

Correspondence Address: Dr. BANGER SHIA;Patent Office of Bang Shia, 102 Lindencrest Ct., Sugar Land, TX, 77479-5201, US

(21) Appl. No.: 12/269,033

(22) Filed: Nov. 11, 2008

(51) Int. Cl. F16H 25/12

(52) U.S. Cl. 74/89.33

(57) ABSTRACT

An actuator with an anti-loose structure comprises an actuator and an anti-loose structure. The actuator includes a first tube, a second tube and a drive assembly. The first tube is movably mounted on the second tube, and the drive assembly is drivingly connected to the first and the second tubes and provided with a drive gear connected to a power source. The drive assembly obtains the power through the drive gear to drive the second tube to life and descend with respect to the first tube. The anti-loose structure includes a first limit member and a second limit member that are both disposed on the drive screw of the drive assembly. The first limit member and the second limit member are respectively located at two ends of the drive gear to for avoiding the uncontrollable movement of the drive gear, which is likely to affect extending/retracting movement of the actuator.

### BACKGROUND OF THE INVENTION

1. Field of the Invention

The present invention relates to an actuator, and more particularly to an actuator with an anti-loose structure.

2. Description of the Prior Art

With the rapid development of technical industry, in order to meet the automation needs of the equipments (such as smoke exhausting window, automatic door, cabinet, satellite antenna, elevating wheelchair, hoisting hospital bed, drawing table, massage chair, traffic equipment, or elevating computer desk) an actuator was developed on the market.

Referring to FIG. 1, a conventional actuator 10 comprises a first tube 11 and a second tube 12. The first tube 11 is movably mounted on the second tube 12. A drive screw 13 is axially pivoted in the first tube 11 and provided with an axial driven nut 14, a limit member 15, a fixed sleeve 16, and a sensing sleeve 17. A drive gear 18 is mounted on the fixed sleeve 16. The drive screw 13 is connected to the drive gear 18 and the power source through the fixed sleeve 16. One end of the second tube 12 is fixed at one end of the driven nut 14, so that the second tube 12 can be subjected to a push force to extend and retract on the first tube 11.

Based on a further analysis of the above conventional actuator, it can be found that it still has the following disadvantages:

The fixed sleeve 16 (as shown in FIG. 2) is screwed with the drive screw 13, so that when the drive gear 18 is rotated clockwise, the fixed sleeve 16 will be driven by the drive gear 18 to rotate clockwise on the drive screw 13, at this moment, the fixed sleeve 16 which is rotating clockwise will press against the limit member 15 upwards. However, when the drive gear 18 is rotated counterclockwise, the fixed sleeve will be driven by the drive gear 18 to rotate counterclockwise on the drive screw 13, at this moment, the fixed sleeve 16 which is rotating counterclockwise will push the sensing sleeve 17, so that the sensing sleeve 17 will be pressed against by the fixed sleeve 16 to deform or even fracture. The sensing sleeve 17 employs a sensor to perform displacement sensing operation, so that once the sensing sleeve 16 is damaged, the function of sensing displacement cannot be performed, thus affecting the normal operation of the actuator 10. Therefore, it is necessary to disassemble the actuator 10 to repair or replace the damaged sensing sleeve 16. However, although the damaged sensing sleeve 16 can be replaced, the above condition will continue to occur, thus causing the waste of repair time and material cost, which both weaken the customer trust in the actuator 10.

The present invention has arisen to mitigate and/or obviate the afore-described disadvantages.

### SUMMARY OF THE INVENTION

The present invention relates to an actuator with an anti-loose structure, which can utilize the anti-loose structure to avoid the uncountable movement of relevant members.

In order to achieve the above objective, the actuator with an anti-loose structure in accordance with the present invention comprises an actuator and an anti-loose structure.

The actuator includes at least two tubes and a drive assembly. One of the two tubes is movably mounted on the other of the two tubes. The drive assembly includes a drive screw, a driven nut and a drive gear. One end of the drive screw is pivoted to one of the tubes of the actuator. The drive gear and the driven nut are disposed on the drive screw. The other of the tubes of the actuator is disposed on the driven nut.

The anti-loose structure includes a first limit member and a second limit member. The first limit member is disposed on the drive screw of the drive assembly in such a manner that the first limit is located at one end of the drive gear, and the second limit member is disposed on the drive screw of the drive assembly in such a manner that the second limit member is locate at the other end of the drive gear.

Further analysis shows that the present invention has the following advantages: the drive gear of the drive assembly of the present invention is limited by the first limit member and the second limit member of the anti-loose structure, so that the members neighboring the drive gear can be prevented from being damaged due to the uncontrollable movement of the drive gear, thus extending the service life of the neighboring members of the drive gear. Therefore, it is not required to waste time on repair, and the material cost can be relatively saved, thus enhancing customer trust in actuator.

### BRIEF DESCRIPTION OF THE DRAWINGS

FIG. 1 is a cross sectional view of a conventional actuator;

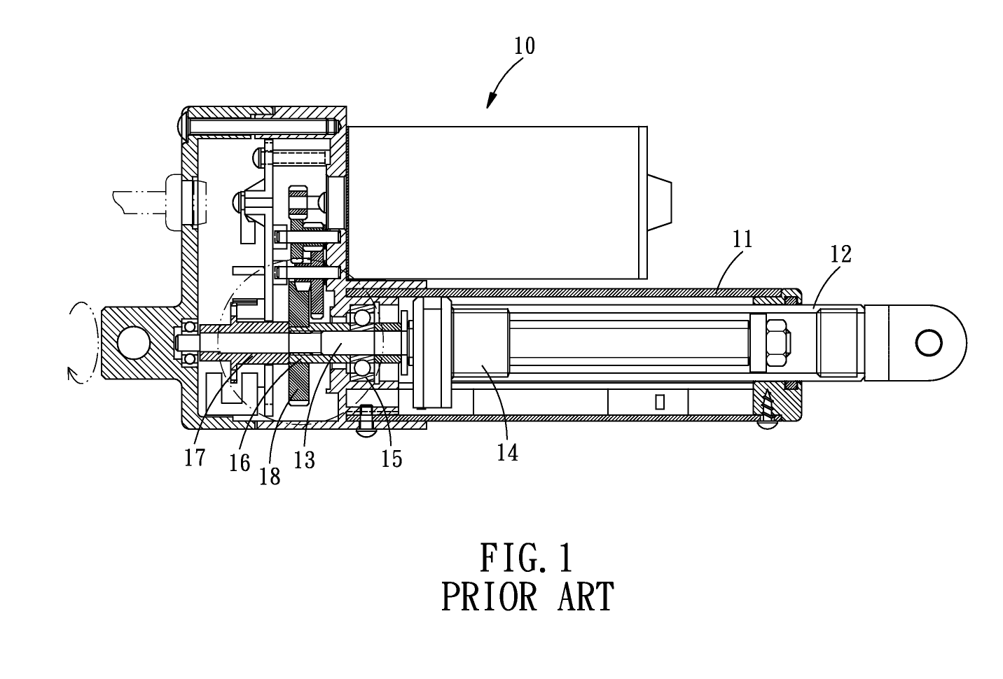

FIG. 2 is a partial enlarged view of the conventional actuator of FIG. 1;

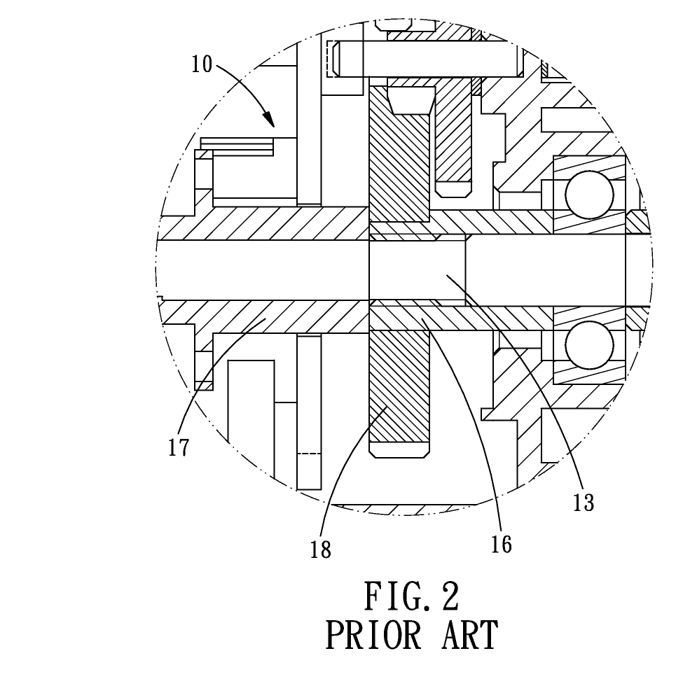

FIG. 3 is a cross sectional view of an actuator in accordance with the present invention; and

FIG. 4 is a partial enlarged view of actuator in accordance with the present invention of FIG. 3.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

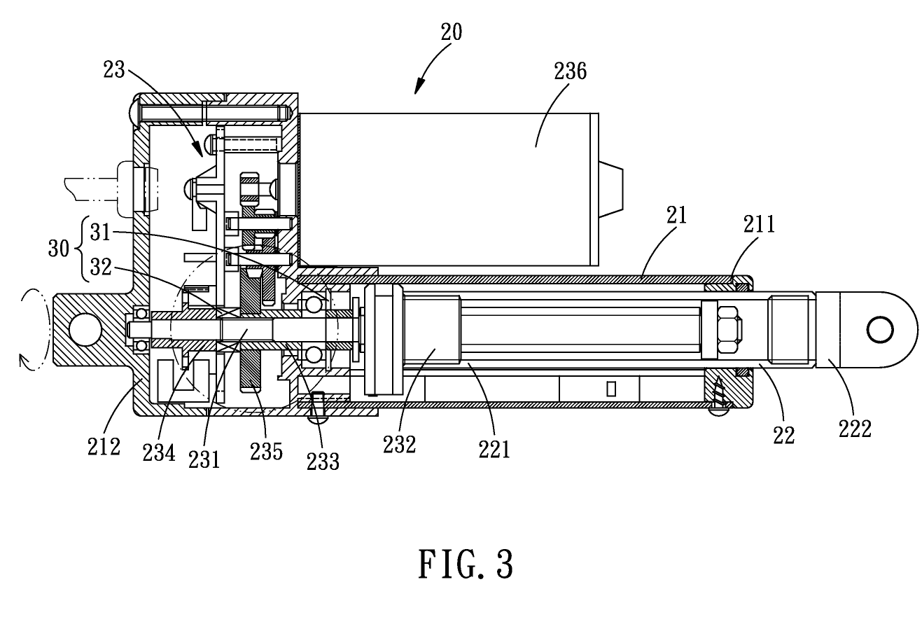

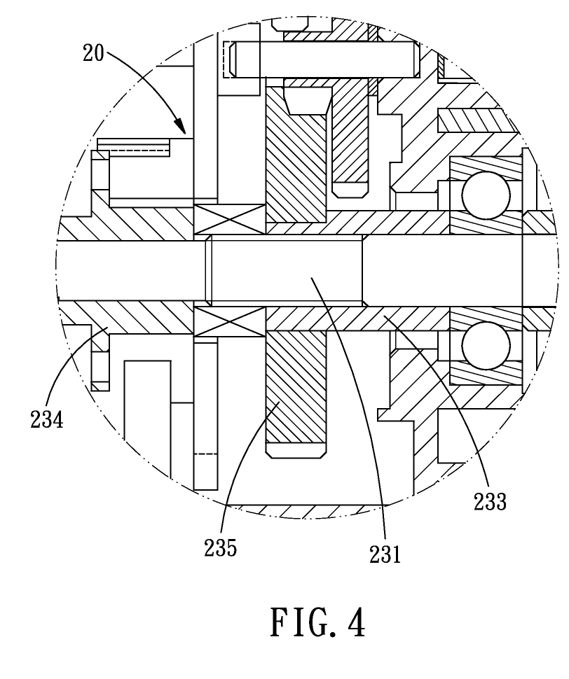

Referring to FIGS. 3-4, an actuator with an anti-loose structure in accordance with the present invention comprises an actuator 20 and an anti-loose structure 30.

The actuator 20 includes a first tube 21, a second tube 22 and a drive assembly 23.

The first tube 21 is oppositely provided with an open end 211 and a closed end 212. The second tube 22 is oppositely provided with an open end 221 and a closed end 222. The second tube 22 is smaller than the first tube 21 in cross section. The second tube 22 is movably installed in the first tube 21 in such a manner that the open end 221 of the second tube 22 is opposite the open end 211 of the first tube 21. The direction in which the second tube 22 is assembled to the first tube 21 is the same as the extending/retracting direction of the second tube 22 with respect to the first tube 21.

The drive assembly 23 includes a drive screw 231, a driven nut 232, a fixed sleeve 233, a sensing sleeve 234, a drive gear 235 and a motor 236. One end of the drive screw 231 is axially disposed on the closed end 212 of the first tube 21 of the actuator 20, and the other end of the drive screw 231 extends toward the closed end 222 of the second tube 22 of the actuator 20. The sensing sleeve 234, the fixed sleeve 233 and the driven nut 232 are successively disposed on the drive screw 231, and the drive gear 235 is mounted on the fixed sleeve 233. The drive gear 235 is drivingly connected to the motor 236 to obtain the rotary power. In the present embodiment, the motor 236 serves as the power source, but the power source of the present invention is not limited to the motor, and it can also be other power devices as desired. One end of the driven nut 232 is coaxially opposite the open end 221 of the second tube 22 in such a manner that the open end 221 of the second tube 22 can be engaged on the driven nut 232. When the drive gear 235 obtains power to drive the drive screw 231 to rotate in place through the fixed sleeve 233, the driven nut 232 will move along the drive screw 231 to drive the second tube 22 to extend/retract with respect to the first tube 21.

The anti-loose structure 30 includes a first limit member 31 and a second limit member 32. The first limit member 31 is a bearing, and the second limit member 32 is a nut. The first limit member 31 is mounted on the drive screw 231 of the drive assembly 23 in such a manner that the first limit member 31 is located between the driven nut 232 and the fixed sleeve 233. The second limit member 32 is locked on the drive screw 231 of the drive assembly 23 in such a manner that the second limit member 32 is located between the fixed sleeve 233 and the sensing sleeve 234. By such arrangements, both ends of the fixed sleeve 233 are limited by the first limit member 31 and the second limit member 32.

When the drive gear 235 rotates clockwise, the fixed sleeve 233 will be driven by the drive gear 235 to rotate clockwise on the drive screw 231, at this moment, the fixed sleeve 233 which is rotating clockwise will be stopped and limited by the first limit member 31. When the drive gear 235 rotates counterclockwise, the fixed sleeve 233 will be driven by the drive gear 235 to rotate counterclockwise on the drive screw 231, at this moment, the fixed sleeve 233 which is rotating counterclockwise will be limited by the second limit member 32.

As known from the abovementioned, under the condition that both ends of the fixed sleeve 233 are limited by the first limit member 31 and the second limit member 32, even though the fixed sleeve 233 is driven by the drive gear 235, it cannot be moved uncontrollably. Therefore, the fixed sleeve 233 can be prevented from pressing against the sensing sleeve 234, thus avoiding the damage to the sensing sleeve 234, and the user doesn't need to disassemble the actuator 20 to repair and replace the sensing sleeve 234.

While we have shown and described various embodiments in accordance with the present invention, it is clear to those skilled in the art that further embodiments may be made without departing from the scope of the present invention.

What is claimed is:

1. An actuator with an anti-loose structure comprising:
an actuator including a first tube, a second tube and a drive assembly, the first tube being movably mounted on the second tube, the drive assembly including a drive screw, a driven nut, a fixed sleeve and a drive gear, one end of the drive screw being pivoted to the first tube of the actuator, the driven nut and the fixed sleeve being mounted on the drive screw, one end of the second tube being disposed on the driven nut, the drive gear being disposed on the fixed sleeve and driven by a power source; and
an anti-loose structure including a first limit member and a second limit member, the first limit member being disposed on the drive screw of the drive assembly in such a manner that the first limit member is positioned at one end of the fixed sleeve, the second limit member being disposed on the drive screw of the drive assembly in such a manner that the second limit member is positioned at the other end of the fixed sleeve.

2. The actuator with an anti-loose structure as claimed in claim 1, wherein the first tube of the actuator is oppositely provided with an open end and a closed end, the second tube of the actuator is oppositely provided with an open end and a closed end, the second tube is movably assembled in the first tube in such a manner that the open end of the second tube is opposite the open end of the first tube.

3. The actuator with an anti-loose structure as claimed in claim 1, wherein the driven assembly of the actuator further includes a sensing sleeve, the sensing sleeve is disposed on the drive screw and located at an end of the fixed sleeve.

4. The actuator with an anti-loose structure as claimed in claim 1, wherein the first limit member of the anti-loose structure is a bearing, the second limit member of the anti-loose structure is a nut.

5. An actuator with an anti-loose structure comprising:
an actuator including a first tube, a second tube and a drive assembly, the first tube being movably mounted on the second tube, the drive assembly including a drive screw, a driven nut and a drive gear, one end of the drive screw being pivoted to the first tube of the actuator, the drive gear and the driven nut being disposed on the drive screw, one end of the second tube being disposed on the driven nut, the drive gear being driven by a power source; and
an anti-loose structure including a first limit member and a second limit member, the first limit member being disposed on the drive screw of the drive assembly in such a manner that the first limit member is positioned at one end of the drive gear, the second limit member being disposed on the drive screw of the drive assembly in such a manner that the second limit member is positioned at the other end of the drive gear.

6. The anti-loose structure with an anti-loose structure as claimed in claim 5, wherein the first tube of the actuator is oppositely provided with an open end and a closed end, the second tube of the actuator is oppositely provided with an open end and a closed end, the second tube is movably assembled in the first tube in such a manner that the open end of the second tube is opposite the open end of the first tube.

7. The anti-loose structure with an anti-loose structure as claimed in claim 5, wherein the drive assembly of the actuator further includes a fixed sleeve and a sensing sleeve, the fixed sleeve and the sensing sleeve are disposed on the drive screw, respectively in such a manner that the fixed sleeve is limited by the first limit member and the second limit member of the anti-loose structure, the drive gear is mounted on the fixed sleeve, and the sensing sleeve is located at an end of the fixed sleeve.

8. The anti-loose structure with an anti-loose structure as claimed in claim 5, wherein the first limit member of the anti-loose structure is a bearing, the second limit member of the anti-loose structure is a nut.
